(19) United States
(12) Patent Application Publication
(10) Pub. No.: US 2009/0074251 A1
(43) Pub. Date: Mar. 19, 2009

(54) Method and System for Determining a Force and/or Torque Applied to an Orthodontic Bracket

(76) Inventors: Robert Steven Sears, Round Hill, VA (US); William Stuart Trimmer, Hillsborough, NJ (US)

Correspondence Address: NIXON & VANDERHYE, PC, 901 NORTH GLEBE ROAD, 11TH FLOOR, ARLINGTON, VA, 22203, US

(21) Appl. No.: 12/226,816

(22) PCT Filed: Apr. 30, 2007
(86) PCT No.: PCT/US2007/010494

§ 371 Date: Oct. 29, 2008

Related U.S. Application Data
(60) Provisional application No. 60/796,524, filed on May 2, 2006.

(51) Int. Cl. G06K 9/00

(52) U.S. Cl. 382/106

(57) ABSTRACT

A method and system are disclosed for analyzing images of fiducials that provide an indication of the forces and/or torques applied to an orthodontic bracket. The mass of each of the pixels forming the fiducial image are multiplied by the square of the distance of the pixel along the image's x axis, the product of the distances of the pixel along the image's x and y axes, and the square of the distance of the pixel along the image's y axis. The second order moments of inertia about the centroid of the fiducial are calculated and used to form a first matrix. The first matrix is diagonalized into a second matrix, from which the fiducial 's first and second principal axes are determined. These axes are then used to measure the size of the fiducial in the image.

### CROSS-REFERENCE TO RELATED APPLICATION

This application claims the benefit of Provisional Application No. 60/796,524, filed May 2, 2006, the entire contents of which is hereby incorporated by reference in this application.

### BACKGROUND OF THE INVENTION

The present invention relates generally to the field of orthodontics. In especially preferred embodiments, the present invention relates to orthodontic brackets which include a force-responsive component by which the magnitude and/or direction of an applied force may be determined optically.

### BRIEF DESCRIPTION OF THE INVENTION

Orthodontic brackets typically are attached to individual teeth and connected to an archwire so as to apply appropriate force over time to move and straighten teeth. Specifically, teeth are moved and rotated by applying forces to the brackets via the archwire. Periodic visits to the orthodontist are therefore required so that the assembly may be checked and adjusted to ensure the proper amount and direction of force is being applied by the archwire to the teeth via the brackets. Adjustment of the archwire is, however, a highly subjective endeavor. Orthodontists therefore gain practical knowledge of the amount and direction of force that is needed for an individual orthodontic patient. It would, however, be highly advantageous if the magnitude and direction of force applied to an orthodontic bracket could be determined objectively. It is towards fulfilling such a need that the present invention is directed.

Broadly, the present invention is embodied in a force-responsive orthodontic bracket. More specifically, the orthodontic bracket of the present invention allows for the objective determination of the magnitude and/or direction of force applied to the tooth to which the bracket is attached. The present invention is therefore preferably embodied in orthodontic brackets having an elastomeric member which allows one portion of the bracket to be resiliently moveable relative to at least one other portion of the bracket. The bracket preferably includes an indicator (e.g., fiducial marks) which distort in response to movement of the bracket portions relative to one another, whereby the indicator distortion is indicative of the magnitude and/or direction of a force applied to the bracket.

In especially preferred embodiments, the present invention includes a force-responsive orthodontic bracket having a lower base member, an upper bracket member, and an elastomeric layer interposed between the lower base and upper bracket members. The elastomeric layer therefore comprises an elastomeric member which allows the upper bracket member to be moveable resiliently relative to the lower base member.

The orthodontic brackets of the present invention are advantageously employed as part of a system whereby the bracket includes an indicator for an indicator of force applied to the upper bracket member sufficient to cause resilient movement of the upper bracket member relative to the lower base member. An optical detector may be provided to optically detect the indicator and issue an output signal indicative of the relative resilient movement between the lower base and upper bracket members. A processor receives the output signal from the optical detector to provide an indication of magnitude and/or direction of the force applied to the upper bracket member.

These and other aspects and advantages will become more apparent after careful consideration is given to the following detailed description of the preferred exemplary embodiments thereof.

### BRIEF DESCRIPTION OF THE DRAWINGS

Reference will hereinafter be made to the accompanying drawings, wherein like reference numerals throughout the various FIGURES denote like structural elements, and wherein;

FIG. 1 is a schematic perspective view of a system which employs the force-responsive brackets of the present invention;

FIG. 2 is a perspective view of an exemplary force-responsive orthodontic bracket according to the present invention;

FIG. 3 is a side elevation view of the orthodontic bracket depicted in FIG. 2;

FIG. 4 is a greatly enlarged partial side cross-sectional view of an alternative embodiment of an orthodontic bracket according to the present invention;

FIG. 5 is an enlarged partial side cross-sectional view of another alternative embodiment of an orthodontic bracket according to the present invention;

FIG. 6 is an enlarged partial side cross-sectional view of another alternative embodiment of an orthodontic bracket according to the present invention; and

FIG. 7 is an enlarged partial side cross-sectional view of yet another alternative embodiment of an orthodontic bracket according to the present invention.

FIGS. 8a through 8c show in schematic form another embodiment of an orthodontic bracket.

FIG. 9a is a simple bar graph display representing forces or torques applied to a tooth by an orthodontic bracket.

FIG. 9b is a detailed display that shows the bar graph of FIG. 9a plus images from the surfaces of the bracket of FIGS. 8a through 8c with the circular fiducials and numeric values of the motions of such circular fiducials and the corresponding forces and torques.

FIG. 10 is a simplified representation of an optical image in which small light squares or pixels, dark squares or pixels being examined and a circle of pixels represents a red dot fiducial mark being imaged.

FIG. 11 is a graphic depiction of a pixel in a given location along the x and y directions.

FIG. 12 is on optical image showing the approximate size one of the dot fiducial pairs on the bracket of FIGS. 8a-8c.

FIG. 13 is a portion of the image in FIG. 12.

FIG. 14 is FIG. 13 thresholded to a binary image.

FIG. 15 is a schematic representation of the orthodontic bracket of FIGS. 8a-8c, but with two circular fiducials in the upper portion of the bracket and one circular fiducial on the bottom part of the bracket.

FIG. 16 is a graph showing a coordinate transformation from the coordinate system x and y to the coordinate system x′ and y′.

FIG. 17a is a picture of a circle shown on a flat plane.

FIG. 17b is a foreshortened image of the circle shown in FIG. 17a.

FIG. 17c is the circle shown in FIG. 17a at an arbitrary angle.

FIG. 18 is an image of the fiducials of the bracket of FIG. 15 seen at an arbitrary angle.

FIG. 19 is a drawing of an elipse.

### DETAILED DESCRIPTION OF THE INVENTION

### System Components

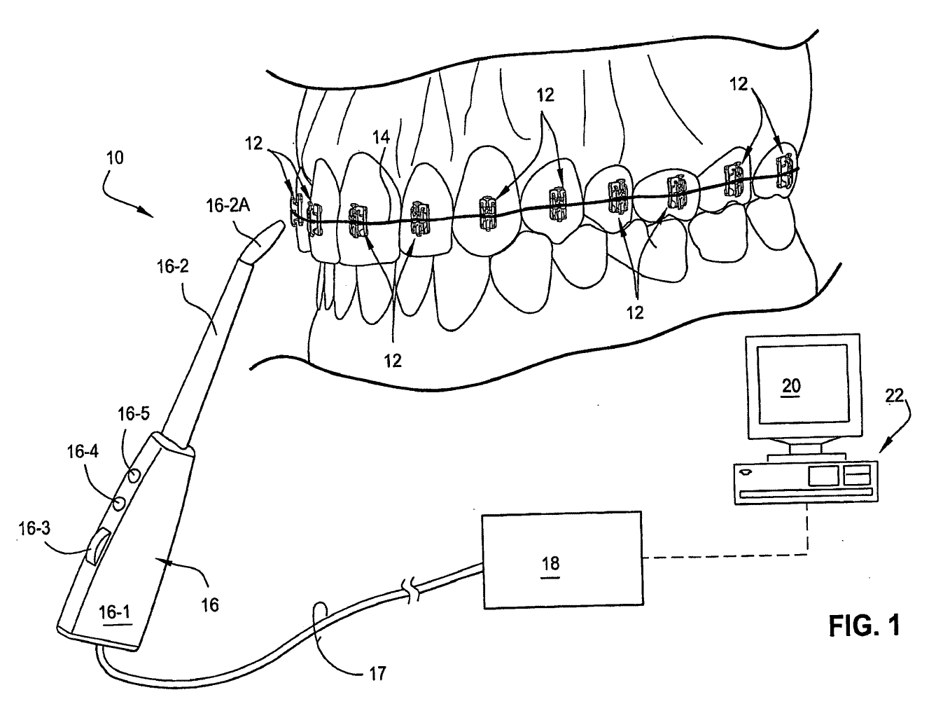

FIG. 1 depicts schematically a system 10 according to the present invention which is especially adapted to detect and present the magnitude and/or direction of force associate with individual ones of the orthodontic brackets 12 which are bonded to the front surfaces of respective teeth in a patient's mouth. As will be explained in greater detail below, the individual brackets 12 are provided with fiducial marks that are indicative of the magnitude and/or direction of force applied to the brackets 12 by means of an archwire 14 attached to, and extending along, the brackets 12.

Generally, according to the present invention, the fiducial marks may be detected optically by means of a hand-held optical detector 16 which takes digital pictures of the fiducial marks and which is operatively connected to a central processor 18 by a signal line 17. The central processor 18 thus receives output signals generated by means of the optical detector 16 via the signal line 17. Central processor 18 can be a microprocessor-based system that is programmed with the necessary algorithms to translate the output signals from optical detector 16 representative of the optically detected indication provided by the fiducial marks into a force magnitude and/or torque that may be displayed to the attending orthodontist, for example, via a conventional monitor 20 associated with personal computer 22. Alternatively, the output signals generated by optical detector 16 may be transmitted to processor 18 wirelessly, for example, using an RF (radio frequency) link.

The hand-held optical detector 16 most preferably includes a proximal handle portion 16-1 and a distal light-emitting wand 16-2. A trigger switch 16-3 is provided on the proximal handle portion 16-1 to allow the orthodontist to activate the wand 16-2 in order to take an optical reading of a particular one of the brackets 12 via the wand tip 16-2a. Light-emitting diodes (LED's) 16-4, 16-5 may also be provided in the handle portion 16-1 and most preferably emit different colors (e.g., red and green) to provide a visual indication to the orthodontist that a satisfactory optical reading of a particular bracket 12 has ensued. The LED's 16-4, 16-5 may also be used to indicate if an acceptable force has been applied to a particular bracket 12. To accomplish such indication, the processor 18 would compare the forces and/or torques applied to the bracket and sensed by the detector 16 to forces and/or torques stored in memory and associated with that particular treatment plan for the individual patient.

### Orthodontic Brackets

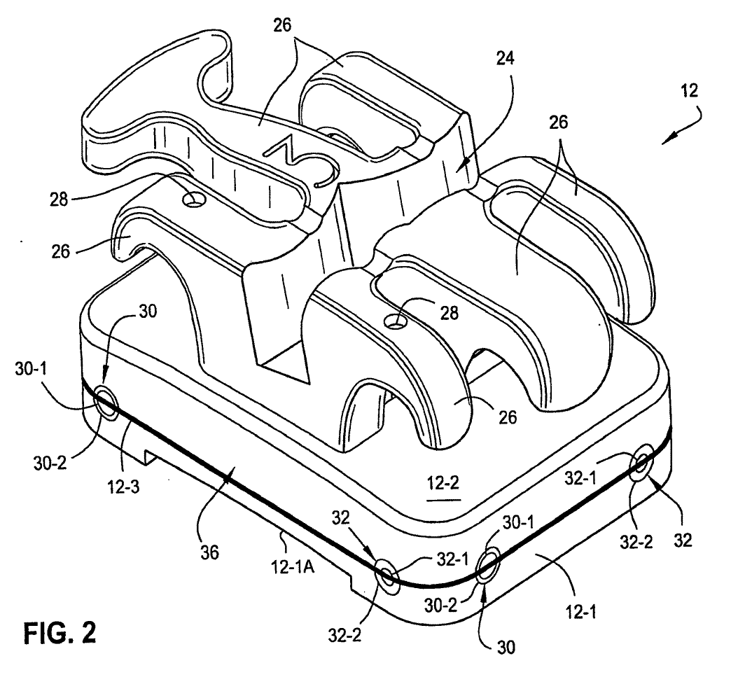

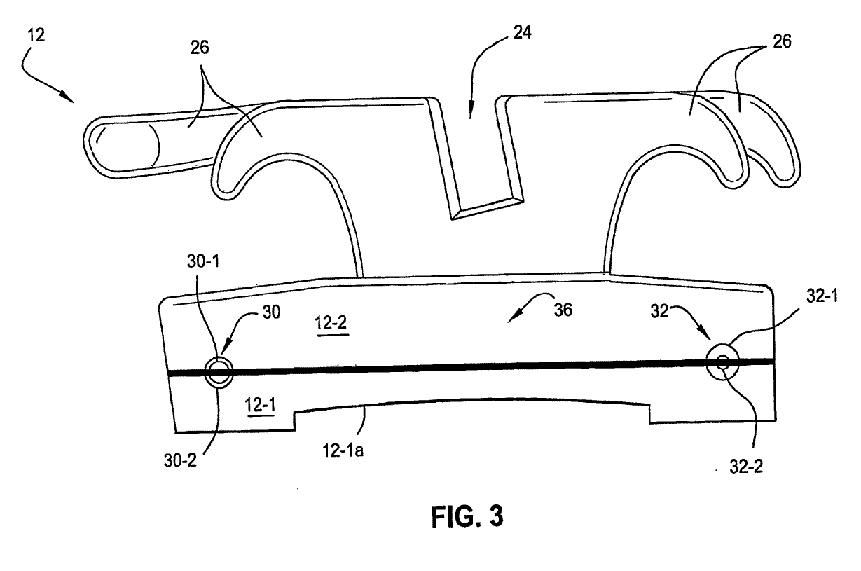

One preferred embodiment of the bracket 12 according to the present invention is depicted in FIGS. 2 and 3. In this regard, it will be observed that the bracket 12 comprises a lower base member 12-1, an upper bracket member 12-2, and an intermediate elastomeric layer 12-3 which resiliently joins the upper bracket member 12-2 to the lower base member 12-1 to thereby allow for slight, but meaningful, relative resilient movement therebetween. Virtually any elastomeric material compatible with orthodontic applications may be used for layer 12-3 and may include for example, EPDM rubber, silicone rubber, and polyester elastomers to name just a few. Suffice it to say that the particular elastomeric material that is employed may be selected by those of ordinary skill in this art without undue experimentation based on the physical properties of the same.

As is conventional, the upper bracket member 12-2 includes a slot 24 for receiving the archwire 14 as well as a plurality of posts 26 and apertures 28 which may be used by the orthodontist to secure additional wires in order to impart the proper force for transfer to the tooth to which the bracket 12 is bonded. The lower bracket member 12-1 most preferably includes a recessed surface 12-1a formed therein to accommodate a bonding material to secure rigidly the base member 12-1 to an underlying tooth so as to, in turn, securely anchor the bracket 12 to the tooth.

The lower base member 12-1 and upper bracket member 12-2 include fiducial marks 30, 32 on multiple visible surface thereof which are divided by the elastomeric layer 12-3 to form upper and lower mark segments 30-1, 32-1 and 30-2, 32-2, respectively. In the absence of applied force, therefore, the upper and lower segments 30-1, 30-2 and 32-1, 32-2 of the fiducial marks 30, 32, respectively, will be aligned with one another. That is, no misregistration between the upper and lower segments 30-1, 30-2 and 32-1, 32-2 of the fiducial marks 30, 32, respectively, will be visibly present.

In response to the application of force, for example via the archwire 14, to the upper bracket member 12-2, the upper and lower segments 30-1, 30-2 and 32-1, 32-2 of the fiducial marks 30, 32, respectively, will therefore become distorted (i.e., misregistered) in dependence upon the magnitude and direction of the applied force by virtue of the elastomeric layer 12-3 which allows the upper bracket member 12-2 to move resiliently with respect to the lower base member 12-1. It is this relative misregistration between the upper and lower segments 30-1, 30-2 and 32-1, 32-2 of the fiducial marks 30, 32, respectively, that may be detected optically by means of the optical detector 16. The relative misregistration between the upper and lower segments 30-1, 30-2 and 32-1, 32-2 of the fiducial marks 30, 32, respectively, detected by the optical detector 16 may thus be communicated to the processing unit 18 wherein the magnitude and/or direction of applied force to a particular bracket is calculated. An appropriate signal is then sent to the personal computer 22 so that the magnitude and/or direction of applied force may be displayed for the orthodontist.

The fiducial marks 30, 32 are shown as being in the form of multiple differently sized concentric circles, although other shapes, such as dots or squares can be used. Such an arrangement therefore allows comparison of one of the upper and lower segments 30-1, 30-2 and 32-1, 32-2 of the fiducial marks 30, 32, respectively, to another so as to arrive at relative misregistrations therebetween. In such a manner, therefore, the magnitude of the applied force may be detected as well as the direction of the applied force relative to six degrees of freedom, namely three mutually orthogonal axes in addition to torque about such axes.

The brackets 12 of the present invention may also carry unique identification indicia 36 which will permit an orthodontist to electronically “tag” each bracket and associate the various force magnitudes and directions thereto. Such unique identification of the individual brackets 12 by the indicia 36 will also allow a historical analysis of its individual movement throughout the orthodontic treatment procedure to be tracked.

The fiducial marks 30, 32 may be of any type suitable for optical detection by means of the detector 16. Thus, for example, the fiducial marks 30, 32 may be formed of any visible media which capable of detection by the optical detector 16, for example, by means of video capture using a miniature video camera within the tip 16-2a of the detector wand 16-2. Alternatively or additionally, the fiducial marks may be formed of phosphorescent or fluorescent media so as to be more visible when irradiated by ultraviolet (UV) light emitted by the optical detector wand 16-2. In such a case, therefore, the detector 16 may be operable (e.g., by operating the trigger switch 16-3 thereof) so as to illuminate the desired bracket 12 with UV radiation, thereby causing the fiducial marks 30, 32 to phosphoresce or fluoresce as the case may be, following which the UV radiation from the wand tip 16-2a may be turned off. An optical comparison may then be made between the fiducial marks 30, 32 based their “on” image and their “off” image. Again, alternatively or additionally, the wand tip 16-2a of the optical detector wand 16-2 may emit laser radiation which scans the fiducial marks 30, 32 so as to detect misregistry therebetween.

An alternative embodiment of a bracket 12′ in accordance with the present invention is shown in FIG. 4. As depicted, the bracket 12′ is similar to the bracket 12 as discussed previously in that it includes a lower base member 12-1′, an upper bracket member 12-2′, and an intermediate elastomeric layer 12-3′ which resiliently joins the upper bracket member 12-2′ to the lower base member 12-1′ to thereby allow for slight, but meaningful, relative resilient movement therebetween. However, instead of or in addition to the fiducial marks 30, 32, there are provided a series of opposed grooves 40, 42 formed respectively in the lower base member 12-1′ and the upper bracket member 12-2′. These grooves 40-42 are registered in the absence of any force applied to the upper bracket member 12-2′, but will become slightly misregistered with one another in response to the application of force to the upper bracket member 12-2′. That is, the upper bracket member 12-2′ is able to be resiliently displaced relative to the lower base member 12-1′ by virtue of the intermediate elastomeric layer 12-3′ which joins the members 12-1′ and 12-2′ one to another. Such misregistration of the grooves 40, 42 may thus be detected optically by the optical detector 16 in a manner similar to that described previously. The grooves 40, 42 also assist structurally to enhance anchoring of the elastomeric layer 12-3′ to each of the lower base and upper bracket members 12-1′ and 12-2′, respectively. As shown, the grooves 40, 42 are opposed V-shaped elements, but other geometric forms such as rectangularly, semicircular or hemispherically shaped elements, could be employed for the purpose of the present invention.

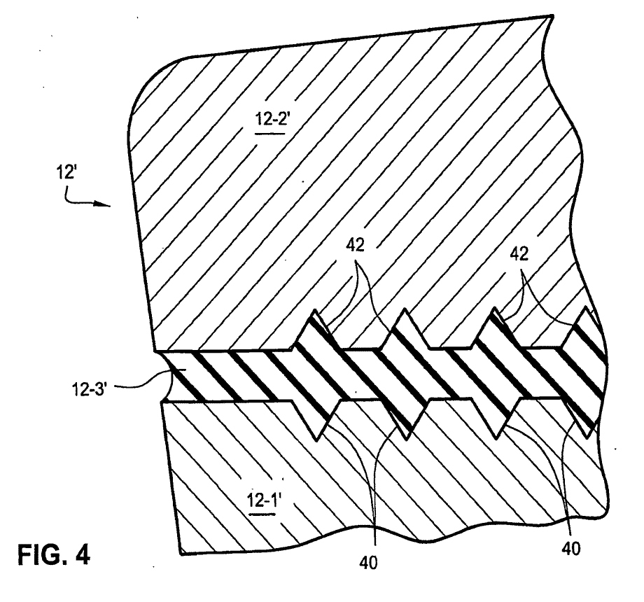

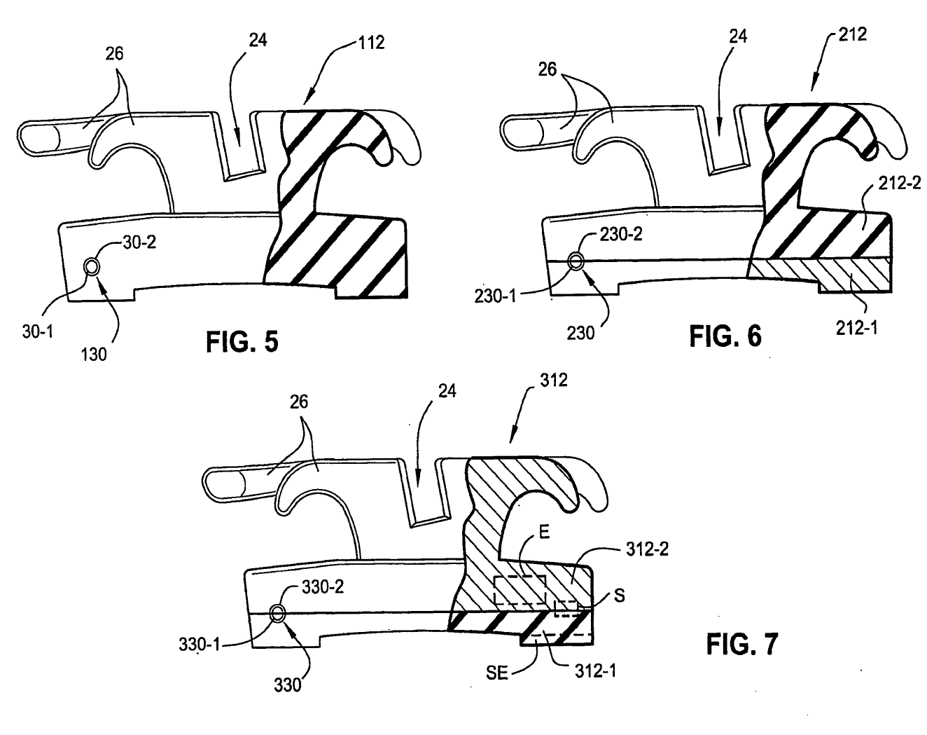

FIGS. 5-7 depict alternative embodiments in accordance with the present invention. In this regard, it will be observed from FIG. 5 that the entire bracket 112 is formed of an elastomeric material and includes a plurality of fiducial marks 130 comprised of concentrically disposed inner and outer marks 130-1, 130-2, respectively. In this regard, only a single fiducial mark 130 is visible in FIG. 5, it being understood that several such fiducial marks 130 will be provided in the manner as described previously. The fiducial marks 130 are either imprinted on a visible surface of the bracket 112 or embedded physically therewithin. In this latter possibility, the elastomeric material from which the bracket 112 is formed is most preferably translucent or transparent so that the detector 16 may visibly detect the fiducial mark 130 embedded therewithin. Forces applied to the bracket 112 will therefore cause portions of the bracket to be moveable or flexed thereby distorting the fiducial marks 130. The amount and direction of such distortion may then be detected by the detector 16 so as to detect the magnitude and/or direction of the applied force.

FIGS. 6 and 7 depict further alternative embodiments of brackets 212 and 312, respectively in accordance with the present invention. In this regard, the bracket 212 of FIG. 6 is comprised of a lower base member 212-1 which is formed of metal and an upper bracket member 212-2 formed entirely of an elastomeric material. The bracket 212 includes a plurality of fiducial marks 230 comprised of concentrically disposed inner and outer marks 230-1, 230-2, respectively. In this regard, only a single fiducial mark 230 is visible in FIG. 6, it being understood that several such fiducial marks 230 will be provided in the manner as described previously.

FIG. 7, on the other hand, depicts a bracket 312 in accordance with the present invention where the lower base member 312-1 is formed of an elastomeric material and the upper bracket member 312-2 is formed of metal. The bracket 312 includes a plurality of fiducial marks 330 comprised of concentrically disposed inner and outer marks 330-1, 330-2, respectively. In this regard, only a single fiducial mark 230 is visible in FIG. 7, it being understood that several such fiducial marks 330 will be provided in the manner as described previously.

In both of the embodiments depicted in FIGS. 6 and 7, therefore, the upper bracket members 212-2 and 312-2 are capable of resilient movement relative to the lower base members 212-1 and 212-2, respectively.

### Force Measurement

As described previously, the force measuring orthodontic bracket 12 includes a base 12-1 that attaches to a tooth and a top 12-2 that receives the force generating arch wire 14. Between the base 12-1 and the top 12-2 is an elastic layer 12-3 that lets the top move relative to the base when forces from the arch wire are applied. The motions of fiducial marks on the top 12-2 relative to fiducial marks 12-1 on the base are used to calculate the forces and torques applied to bracket 12.

The present invention uses a micro system for detecting forces applied by an orthodontic bracket 12. The micro force sensors in this are small enough to be integrated into an orthodontic bracket 12. Orthodontic brackets 12 are typically about 3 mm by 4 mm by 5 mm (height by width by length). The corners of the brackets 12 can be beveled, preferably at forty five degrees, and fiducials a fraction of a millimeter wide are placed on the beveled corners. To form the micro system, the elastic layer 12-3 is placed inside the bracket 12. Forces distort the elastic layer 12-3, so that the fiducials on the base 12-1 and top 12-2 of the bracket 12 move with respect to one another. A micro vision system detects the motions between the fiducials, and metrology algorithms calculate the forces and torques applied by the bracket 12 to a tooth. Software first calculates the center of mass for the upper fiducial. Then the moment of inertia of this fiducial is found and diagonalized to find the orientation of the fiducial in the image. The center of mass of the lower fiducial is then determined, and used to determine their relative motion. The relative motions of the fiducials at the four corners are then used to calculate the forces and torques.

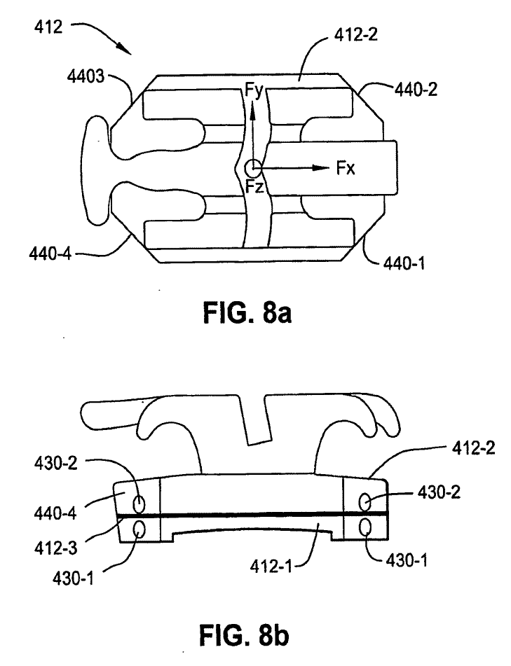

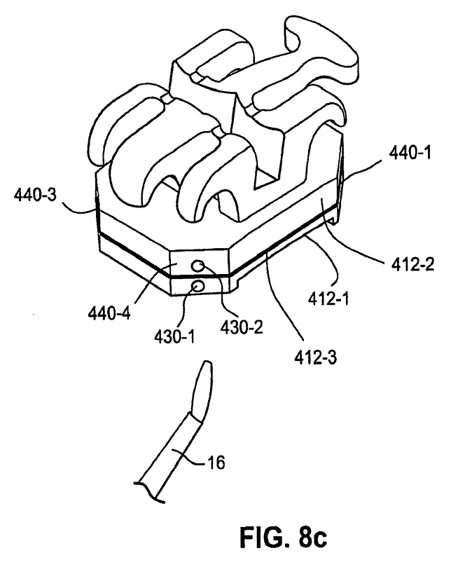

A schematic depiction of another embodiment of an orthodontic bracket 412 is shown in FIGS. 8a through 8c. The four corners of the bracket 412 are removed so as to form four flat surfaces 440-1 to 440-4 on which fiducial marks are placed. For the embodiment of orthodontic bracket 412 shown in FIGS. 8a through 8c, the fiducial marks are in the form of dots, although it should be noted that other forms of marks could be used. Thus, the base and top dots, 430-1 and 430-2, respectively, are positioned on each of the flat surfaces 404-1 to 440-4.

It should be noted, however, that the dots could be located on other surfaces, such as the side and end surfaces of bracket 412 between the four corners. A minimum of three surfaces, all in different planes, is needed to practice the present invention. The dots 430-1 and 430-2 on each of the flat surfaces 440-1 to 440-4 are imaged by optical detector 16, so as to detect relative motion between the top dots 430-2 and the bottom dots 430-1. Mathematical equations are used to calculate the forces and torques applied to teeth by orthodontic brackets 412. For example, when the arch wire 414 pulls up on the top 412-2 of bracket 412, the elastic layer 412-3 stretches, and all four top dots 430-2 move up in response to this force. The upward force is proportional the upward motion of the four dots. A vision algorithm is used to find the center of mass of each dot, 430-1 and 430-2. Knowing the positions of these dots on the four flat surfaces 440-1 to 440-4 and the spring constant of the elastic layer 412-3, allows the calculation of the forces and torques applied by bracket 412 to a tooth.

As optical detector 16 images each of the four flat surfaces 440-1 to 440-4 of the bracket 412 to thereby image the dots 430-1 and 430-2 positioned on these surfaces, the images are sent through wire 17 to processor 18 and preferably stored as .bmp files. Because optical detector 16 is hand held, the scale factor of the images of the dots can change. For, example one image of the fiducial dots may be 150 pixels wide with a scale factor of 1 mm=100 pixels, while another image of other dots might be twice the size of the first image because of the manner in which the detector is held. In the latter case, the second fiducial dots may be 300 pixels wide with a scale factor of 1 mm=200 pixels.

Not only can the scale size change as the optical detector 16 is moved, but the perspective of the images can also change. Since the top and bottom fiducial dots, 430-2 and 430-1, are identical, their apparent size in the image of them captured by optical detector 16 is used to correct for perspective and find the scale size in the image. Software in processor 18 first calculates the center of mass for the top dot 430-2. Then the moment of inertia of the top dot 430-2 is found and diagonalized to find the orientation of the top dot in the image.

The center of mass of the bottom fiducial dot 430-1 is then determined, and used to determine the relative motion between the top and bottom fiducial dots. The relative motions of the top and bottom dots at the four corners are then used to calculate the forces and torques applied by orthodontic brackets 412 to teeth.

The moment of inertia is given by:

$$\{ I \} = \begin{matrix}{Σ}_{i} {m}_{i} * {y}_{i}^{2} & - {Σ}_{i} {m}_{i} * {x}_{i} * {y}_{i} \\ - {Σ}_{i} {m}_{i} * {x}_{i} * {y}_{i} & {Σ}_{i} {m}_{i} * {x}_{i}^{2}\end{matrix}$$

where the sum is over all the pixels considered and the mass, m, of each pixel is 1 if the correct color is present and 0 if not. This results in:

$$\{ I \} = \begin{matrix}{I}_{11} & {I}_{12} \\ {I}_{21} & {I}_{22}\end{matrix}$$

$$where$$

$$\begin{matrix}{I}_{11} = {σ}_{1} {m}_{i} * {y}_{i}^{2} \\ {I}_{12} = - {σ}_{i} {m}_{i} * {x}_{i} * {y}_{i} = {I}_{21} \\ {I}_{21} = - {σ}_{i} {m}_{i} * {x}_{i} * {y}_{i} = {I}_{12} \\ {I}_{22} = {σ}_{i} {m}_{i} * {x}_{i}^{2}\end{matrix}$$

These moments of inertia are about the origin of the vision system coordinates, not about the center of mass. The center of mass of a fiducial is given by:

xcm=σᵢmᵢ*xᵢ/σᵢmᵢ

and

ycm=σᵢmᵢ*yᵢ/σᵢmᵢ

Steiner's parallel-axis theorem states:

Iᵢⱼ=Jᵢⱼ−M*(a²δᵢⱼ−aᵢ*aⱼ)

where a is the vector from the origin of the vision system to the center of mass of the object, Iᵢⱼ is the moment of inertia about the center of mass, M is the total mass of the object and δᵢⱼ=1 if i=j, else 0.

I₁₁=J₁₁−M*y²

I₁₂=J₁₂+M*x*y

I₁₂=J₂₁+M*x*y

I₂₂=J₂₂−M*x²

This results in the moment of inertia about the center of mass of the fiducial.

If the cross terms, I₁₂ and I₂₁, are non zero, then the axis of the vision system is not aligned with the principal axes of the fiducial of interest. This is normally the case.

Now to use an analogy:

Lᵢ=σⱼIᵢωⱼ

Because the moment of inertia, Iᵢ, has cross terms, the angular momentum, Lᵢ, need not be in the same direction as the angular velocity, ω. The proper rotation will diaogonalize Iᵢ and the new coordinate system will be aligned with the principal axes of the fiducial. The principal axis of a circle is the longest line running through the center of the circle. By diagonalizing Iᵢ, the rotation angle of the object relative to the vision system can be found. And the values of the diagonalized Iᵢ are used to find the dimensions of the fiducial.

### Now

$$\vert \begin{matrix}{x}^{′} \\ {y}^{′}\end{matrix} \vert = \vert \begin{matrix}{I}_{11} & {I}_{12} \\ {I}_{21} & {I}_{22}\end{matrix} \vert \vert \begin{matrix}x \\ y\end{matrix} \vert$$

has a characteristic equation

$$0 = \vert \begin{matrix}{I}_{11} - μ & {I}_{12} \\ {I}_{21} & {I}_{22} - μ\end{matrix} \vert$$

$$and$$

$$\begin{matrix}0 = ( {I}_{11} - μ ) * ( {I}_{22} - μ ) - {I}_{12} * {I}_{21} \\ = {I}_{11} * {I}_{22} + {μ}^{2} - μ ( {I}_{11} + {I}_{22} ) - {I}_{12} * {I}_{21}\end{matrix}$$

Using the quadratic equation, two values for μ, μ₁ and μ₂, can be found.
The eigenvector condition is:

μ*x=I₁₁*x+I₁₂*y

Using the μ values and solving the y gives

y₁=μ₁*(x−I₁₁)/I₁₂

and

y₂=μ₂*(x−I₁₁)/I₁₂

Using one of the above equations, if x is set to 1, a value for y can be calculated. The vector sum of this x and y is a vector pointing in the direction of one of the fiducial axes. Using the x and y from the other equation above gives a vector in the other axis of the fiducial.

Now, taking one of the vectors defined by x and y above and make it unitary length and dot this vector with a vector of unitary length along, say, the x axis of the vision system, gives the cosine of the angle between the x axis of the vision system and the principal axis of the fiducial. Now, the orientation of the object is known.

Above, the mass, M=σᵢmᵢ, and the principal moments of inertia, I₁ and I₂ have been calculated, where

I₁=⅓*b²*M

and

I₂=⅓*a²*M

The values of a and b can now be calculated.

All the parameters of the fiducial for determining its relative movement have now been calculated, i.e., the mass, the center of mass, the orientation and the dimensions of the fiducial.

Processor 18 uses an Image Acquisition (IA) software that interfaces with a main program. The main program requests images and the IA software obtains the images and notifies the Main software that the images are available. The main program requests four images of the base and top dots, 430-1 and 430-2, positioned on each of the flat surfaces 404-1 to 440-4 of bracket 412. The IA software acquires these four images through optical detector 16. The images are stored, preferably as red/green/blue (RGB) .bmp files, in processor 18. The images can be stored in a file folder (e.g., “Images”) in a storage medium, such as a hard disk, in processor 18. The images can be labeled Image1.bmp, Image2.bmp, Image3.bmp and Image4.bmp. The IA software then signals the main program that the four images are available.

The IA software can be used for the initial alignment and focusing of the optical detector 16. This software allows the examining and adjustment of detector 16 by looking at the image from the detector 16, mechanically aligning and focusing the detector, setting the brightness and performing all of the functions needed to obtain a good image. The IA software for viewing and aligning the optical detector 16 is available while running the main program. The image size is can be preferably either 480 by 640 pixels or 240 by 320 pixels.

To determine the forces and/or torques applied by an orthodontic bracket 412 to a tooth, processor 18 preferably uses metrology software. There are three parts to the metrology software. First is the vision algorithms that find the centroid of the dots 430-1 and 430-2 in each of the images obtained by optical detector 16. The second uses mathematics to find the forces and torques that caused the observed motion of the dots. The third is a display that numerically and graphically shows the results. The main program, which is run by processor 18, calls up subroutines, such as Pixie, Thresh, Array, FindCenter, Calibrate, Mathematics, SimpleDisplay and GeneralDisplay, to analyze the observed motion of the dots 430-1 and 430-2, or any other fiducial marks used with a given orthodontic bracket 12. The main program runs all of the subroutines and displays the results from a new set of images obtained by optical detector 16.

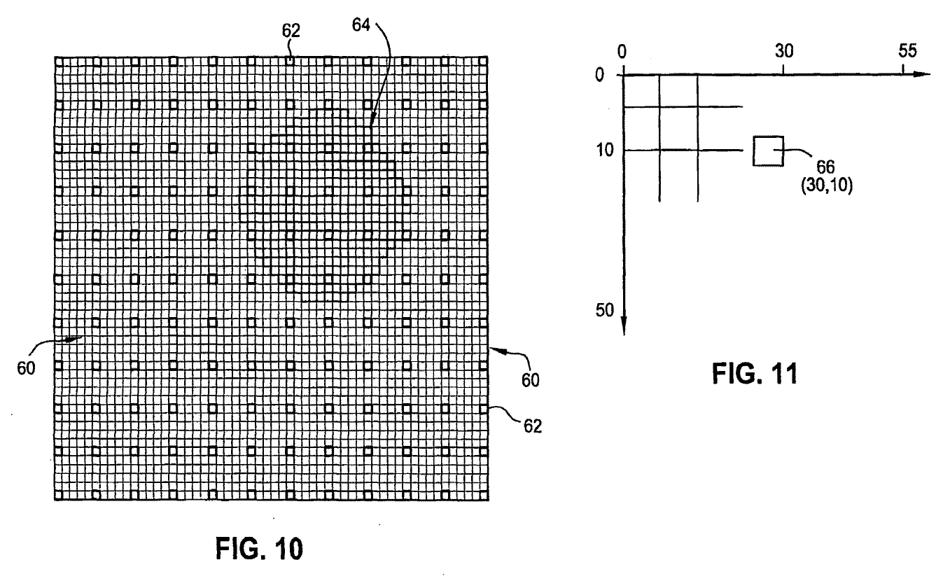

FIG. 10 shows a simplified representation of an optical image in which small light squares 60 are pixels, dark squares 62 are pixels being examined, and a circle of pixels 64 represents a red dot 430-2 (or other fiducial mark) being imaged. The pixels 60 are measured in the X direction from left to right and in the Y direction from top to bottom. A given pixel 66 that is positioned over 30 pixels in the X direction and down 10 pixels in the Y direction will be represented as (30, 10), as shown in FIG. 11. FIG. 10 depicts a red top dot 430-2 that includes 14 pixels that are being examined. They are represented as follows:

| | | | |
|---|---|---|---|
| 25, 15 | 30, 10 | 35, 10 | 40, 10 |
| 25, 20 | 30, 15 | 35, 15 | 40, 15 |
| | 30, 20 | 35, 20 | 40, 20 |
| | 30, 25 | 35, 25 | 40, 25 |

The centroid (also called the center of mass or the center of gravity) of the dot 430-2 is calculated. The X coordinate of the centroid is given by:

Xcentroid=Σᵢmᵢ*xᵢ/Σᵢmᵢ

and the Y coordinate of the centroid is given by:

Ycentroid=Σᵢmᵢ*yᵢ/Σᵢmᵢ

where the mass of the centroid is just its area.
To restate the equation, to find the centroid in the X direction, the object (top dot 430-2) is broken into tiny pieces, and the mass (mᵢ) of each piece is multiplied by its X coordinate; and the sum (Σᵢ mᵢ*xᵢ) of all of these pieces is divided by the total mass (Σᵢ mᵢ) of the object. For convenience, the mass of each pixel is set to be 1.
To find the centroid in the Y direction, the Σᵢ mᵢ*xᵢ summation is:

$$\begin{matrix} & & 30 * 1 + & 35 * 1 + & 40 * 1 \\ + & 25 * 1 + & 30 * 1 + & 35 * 1 + & 40 * 1 \\ + & 25 * 1 + & 30 * 1 + & 35 * 1 + & 40 * 1 \\ & 25 * 1 + & 30 * 1 + & 35 * 1 + & 40 * 1\end{matrix}$$

which is equal to (25*2+30*4+35*4+40*4)=470 The σᵢ mᵢ summation is:

$$\begin{matrix} & & & 1 & + & 1 & + & 1 \\ + & 1 & + & 1 & + & 1 & + & 1 \\ + & 1 & + & 1 & + & 1 & + & 1 \\ & & & 1 & + & 1 & + & 1\end{matrix}$$

which is equal to (2+4+4+4)=14
The centroid in the x direction is:

Xcentroid=Σᵢmᵢ*xᵢ/Σᵢmᵢ=470/14=33.6

To find the centroid in the Y direction, the Σᵢmᵢ*yᵢsummation is:

$$\begin{matrix} & & 10 * 1 + & 10 * 1 + & 10 * 1 \\ + & 15 * 1 + & 15 * 1 + & 15 * 1 + & 15 * 1 \\ + & 20 * 1 + & 20 * 1 + & 20 * 1 + & 20 * 1 \\ & & 25 * 1 + & 25 * 1 + & 25 * 1\end{matrix}$$

which is equal to (10*3+15*4+20*4+25*3)=245
The Σᵢ mᵢ summation is the same as the X direction:

$$\begin{matrix} & & & 1 & + & 1 & + & 1 \\ + & 1 & + & 1 & + & 1 & + & 1 \\ + & 1 & + & 1 & + & 1 & + & 1 \\ & & & 1 & + & 1 & + & 1\end{matrix}$$

which is equal to (2+4+4+4)=14
The centroid in the Y direction is:

Ycentroid=Σᵢmᵢ*yᵢ/Σᵢmᵢ=245/14=17.5

So the centroid coordinates are (33.6, 17.5).

In FIG. 10, the pixel that is determined to be the centroid is not the exact center of the dot. The deviation is due to coarse sampling of the dot, e.g., using a dot on a five by five array. Doing a computation using all of the dots would give a more accurate answer. Also, using a gray scale image and grayscale calculation, rather than a binary image, would likely give a better answer.

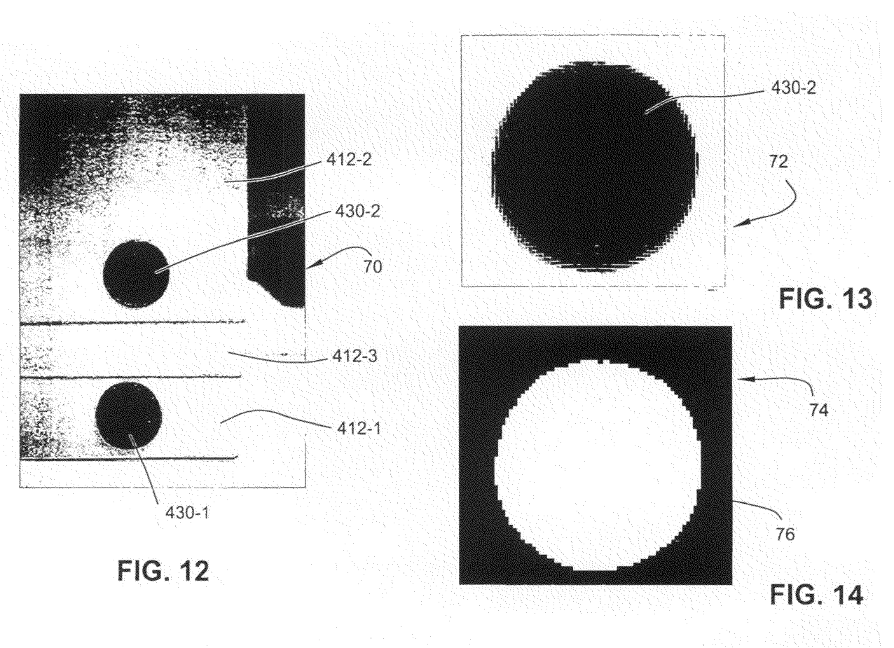

FIG. 12 is an image 70 taken with optical scanner 16 showing the approximate size of the dots 430-1 and 430-2, the field of view and the elastic layer 412-3. According to the method of the present invention, only the position of the upper red dot 430-2 is first measured.

The first analysis of the image 70 uses the algorithm described above, and only looks in the portion of the image 70 shown in FIG. 13. This gives an approximate position of the upper 430-2 dot. The second analysis of the image 60 then needs only to examine the small area around the dot 430-2. This smaller area is shown as image 72 in FIG. 13 to a much higher magnification. The pixels and irregularities in the image 72 shown in FIG. 13 can be seen. If image 72 is thresholded to a binary image, it looks like image 74 in FIG. 14.

The dot 430-2 is now made of white pixels (mᵢ=1) and the surrounding region 76 made of black pixels (mᵢ=0). The best way to threshold the image 72 involves taking a ratio between the red color and the blue and green colors, e.g., R/(G+B). If the ratio is greater than a selected number like 0.8, the pixel is set to 1, otherwise it is set to 0.

A second analysis of the image 72 examines the small region shown in FIG. 13. It may be desirable to examine every pixel in image 72, or perhaps a smaller number, like every other pixel, or every fourth pixel. The detail of this analysis depends upon the accuracy achieved and the time needed to perform the vision algorithm. It should be noted that the first analysis of the image 72 also works with a binary image (FIG. 14) where only those pixels examined have been thresholded. The subroutines used for the first and second analysis are described below. It should be further noted that it is not the pixels in the center of the dot 430-2, but the pixels around the edge of the dot 430-2 that give information about the location of the dot. In a more complicated algorithm, only the edge pixels would be read.

### Subroutines

The subroutines called by the main program are described below. The lines of programming code are written in no particular programming language and are intended as a way of explaining the method of the present invention.

Pixie

The subroutine pixie gets information about the value of the pixel located at (x, y):

pixie (file, x, y, R, G, B)

where file=the name of the file containing the image in .bmp format and where x, y=the x and y coordinates of the pixel. The file could be Pix1.bmp, Pix2.bmp, Pix3.bmp or Pix4.bmp.
R, G, B=the red, green and blue values of the pixels. These values are returned to the program calling pixie.
The subroutine pixie may be called for values of x and y that are outside of the image stored in the file. For example, if the image size is 240 by 320 pixels, a pixel request for (250, 340) is outside the image. In this case, the values R=1, G=1, B=1 should be returned; and the file should not be read. Doing this simplifies the other subroutines:

Return(R, G, B)

Thresh

The subroutine thresh calls pixie to get the values R, G and B. It then turns the color information into a black and white binary image. Thresh can be handled in two different ways. There can be a single thresh subroutine used for red, green, blue and yellow dots, or four routines can be used, one for each color. Using four routines probably results in faster execution time. This approach is used in describing threshR for a red dot 430-2:

;threshR (file, x, y, R, G, B, picval)

file, x, y, R, G, and B defined as in pixie

picval=the binary value (zero or one) of the pixel at x and y in file.

In an alternative program, picval can be a gray scale number between 0 and 1, such that a gray scale analysis is performed.
For the example of the 430-2 dot shown in FIG. 13, picval is calculated as:

picval=(1*R+0*G+0*B)/(0*R+1*G+1*B)

if picval>ThresVal then picval=1 else picval=0 where Thresval is some number like 0.8.

A yellow dot is a bit more complicated because it consists of G and B with little R. Some experimentation is required for a specific yellow dot, but the calculation is typically:

picval=(G/R)*(B/R)

if picval>20 then picval=1 else picval=0

Return(picval)

Array

The array subroutine reads the values of the pixels in the array to be examined and does the mathematics needed to calculate the centroid. In FIG. 14 showing the pixels and a red dot 430-2, the dark boxes are around the pixels to be examined. The “instructions” for carrying these functions may be as follows:

array(file, xstart, xstop, xstep, ystart, ystop, ystep, xcentroid, ycentroid)

file=the name of the file containing the image
xstart=x starting point of array
xstop=x stopping point of array
xstep=the step in the x direction
ystart=y starting point of array
ystop=y stopping point of array
ystep=the step in the y direction
xcentroid=the value of the x direction centroid calculated in this subroutine
ycentroid=the value of the y direction centroid calculated in this subroutine
The programming for the array subroutine will be shown using a For/Next statement

xcentroid=0

ycentroid=0

xmsum=0

ymsum=0

number=0

For nx=xstart to xstop xstep

For ny=ystart to ystop ystep

threshR (file, nx, ny, picval)

xmsum=xmsum+picval*xn

ymsum=ymsum+picval*yn

number=number+picval

Next ny

Next nx

xcentroid=xmsum/number

ycentroid=ymsum/number

Return (xcentroid, ycentroid)

FindCenter

The subroutine findcenter finds the center of the top dot 430-2 in the image 60 being examined and shown in FIG. 13.

In describing this subroutine, reference is made to the image 72 shown in FIG. 13, which is 240 by 320 pixels (x=0 to 240 and y=0 to 320). The dot 430-2 is 60 pixels in diameter, centered on x=100 and y=150. The red dot moves around in the region x=20 to 180 and y 80 to 220. These numbers may change, depending upon the mechanical configuration and the image acquisition software. The “instructions” for performing the function of finding the center of the top dot 430-2 may be as follows:

findcenter(file, xedge1, xedge2, yedge1, yedge2, xcentroid, ycentroid)
in this example,
xedge1=20
xedge2=180
yedge1=80
yedge2=220
The subroutine is:

xstart=xedge1

xstop=xedge2

xstep=10

ystart=yedge1

ystop=yedge2

ystep=10

Call subroutine Array

The result is an approximate center of the red dot located at xcentroid and ycentroid.
The Array subroutine is next used only in the region of the dot

xstart=xcentroid−45

xstop=xcentroid+45

xstep=2

ystart=ycentroid−45

ystop=ycentroid+45

ystep=2

Call Subroutine Array

This results in more accurate values of xcentroid and ycentroid, which are returned to the program calling findcenter.

Return (xcentroid, ycentroid)

Main

Main is the main program that calls other programs.

Main( )

Main sends a request to the Image Acquisition program, which passes the images from the optical detector 16 to the processor 18, which stores four images as files Image1.bmp, Image2.bmp, Image3.bmp and Image4.bmp. The main program then performs an initial calibration and starts taking measurements and calculating the centroids of the upper dot 430-2 for the four images. Two numbers are generated for each image, xcentroid and ycentroid. The four images give eight numbers, which are called A, B, C, D, E, F, G, H.

Running average is used to smooth the data and improve the accuracy from measurement to measurement. The Mathematics subroutine uses the set of eight numbers and calculates the forces and torques applied to the orthodontic brackets 412. The Display subroutine presents the results on the display of Monitor 20 and computers 22. Instructions for carrying out the Main program can be as follows:

Calibrate(xinit1, yinit1, xinit2, yinit2, xinit3, yinit3, xinit4, yinit4)

The xinit1, yinit1, xinit2, yinit2, xinit3, yinit3, xinit4, yinit4 are the original locations of the four dots when no force is applied.

Aint=−yint1

Bint=xint1

Cint=−yint2

Dint=xint2

Eint=−yint3

Fint=xint3

Gint=−yint4

Hint=xint4

Note that the X&Y and the A&B coordinate systems are in different directions, i.e., A has been chosen in the Y direction and B in the X direction. This is a concern only here and the findcenter subroutine called below.

Alast=Aint

Blast=Bint

Clast=Cint

Dlast=Dint

Elast=Eint

Flast=Fint

Glast=Gint

Hlast=Hint

Location A

Location A is returned to from other parts of the program.

running1=1

running2=1

These are flags used in the running average to determine that the data is good.
Findcenter is used to get the values of A, B, C, D, E and F from the four images.

findcenter(Pic1, 20, 180, 80, 220, xcentroid, ycentroid)

A=−ycentroid−Aint

B=xcentroid−Bint

findcenter(Pic2, 20, 180, 80, 220, xcentroid, ycentroid)

C=−ycentroid−Cint

D=xcentroid−Dint

findcenter(Pic3, 20, 180, 80, 220, xcentroid, ycentroid)

E=−ycentroid−Eint

F=xcentroid−Fint

findcenter(Pic4, 20, 180, 80, 220, xcentroid, ycentroid)

G=−ycentroid−Gint

H=xcentroid−Hint

A check is then made to see if the ABCDEFGH's deviate substantially from the last data. If so, this data is eliminated. A running average of the data is kept. A similar running average is also used on the final data of the forces and torques later in this program:

if (A−Alast)/A>0.1 or <0.1 then running1=0

if (B−Blast)/B>0.1 or <0.1 then running1=0

if (C−Clast)/C>0.1 or <−0.1 then running1=0

if (D−Dlast)/D>0.1 or <−0.1 then running1=0

if (E−Elast)/E>0.1 or <−0.1 then running1=0

if (F−Flast)/F>0.1 or <−0.1 then running1=0

if (G−Glast)/G>0.1 or <−0.1 then running1=0

if (H−Hlast)/H>0.1 or <−0.1 then running1=0

RunningRatio=0.6

The RunningRatio determines the weight given to previous data. A new running average is calculated:

Alast=Alast*RunningRation+A*(1−RunningRatio)

Blast=Blast*RunningRation+B*(1−RunningRatio)

Clast=Clast*RunningRation+C*(1−RunningRatio)

Dlast=Dlast*RunningRation+D*(1−RunningRatio)

Elast=Elast*RunningRation+E*(1−RunningRatio)

Flast=Flast*RunningRation+F*(1−RunningRatio)

Glast=Glast*RunningRation+G*(1−RunningRatio)

Hlast=Hlast*RunningRation+H*(1−RunningRatio)

If running1=0 then goto to Location A (just after the calibrate subroutine)

This loops if there is a bad bit of data, if the dots are moving too rapidly for a good measurement or if Main has just started to take data:

Call the subroutine Mathematics(Alast, Blast, Clast, Dlast, Elast, Flast, Glast, Hlast, F1, F2, F3, T1, T2, T3)

The Mathematics subroutine uses the smoothed Alast, etc. to calculate the forces, F's, and the torques, T's. The F's and T's are then smoothed with a second running average:

if (F1−F1last)/F1last>0.1 or <−0.1 then running2=0
if (F2−F2last)/F2last>0.1 or <−0.1 then running2=0
if (F3−F3last)/F3last>0.1 or <−0.1 then running2=0
if (T1−T1last)/T1last>0.1 or <−0.1 then running2=0
if (T2−T2last)/T2last>0.1 or <−0.1 then running2=0
if (T3−T3last)/T3last>0.1 or <−0.1 then running2=0
if (T1−T1last)/T1last>0.1 or <−0.1 then running2=0

RunningRatio=0.5

F1last=F1last*RunningRatio+(1−RunningRatio)*F1

F2last=F2last*RunningRatio+(1−RunningRatio)*F2

F3last=F3last*RunningRatio+(1−RunningRatio)*F3

T1last=T1last*RunningRatio+(1−RunningRatio)*T1

T2last=T2last*RunningRatio+(1−RunningRatio)*T2

T3last=T3last*RunningRatio+(1−RunningRatio)*T3

If running2=0 then goto locationA

At this point, the calculations are complete and the resulting information is sent to the output display:

Call the subroutine Display

goto locationA

End of Main program

Calibrate

Calibrate finds the locations of the dots when no forces are being applied. This subroutine is run with no forces applied to the bracket:

Calibrate(xinit1, yinit1, xinit2, yinit2, xinit3, yinit3, xinit4, yinit4)

xint1=0

yint1=0

xint2=0

yint2=0

xint3=0

yint3=0

xint4=0

yint4=0

For N=1 to 5

findcenter(Pic1, 20, 180, 80, 220, xcentroid, ycentroid)

xint1=xcentroid/5+xint1

yint1=ycentroid/5+yint1

findcenter(Pic2, 20, 180, 80, 220, xcentroid, ycentroid)

xint2=xcentroid/5+xint2

yint2=ycentroid/5+yint2

findcenter(Pic3, 20, 180, 80, 220, xcentroid, ycentroid)

xint3=xcentroid/5+xint3

yint3=ycentroid/5+yint3

findcenter(Pic4, 20, 180, 80, 220, xcentroid, ycentroid)

xint4=xcentroid/5+xint4

yint4=ycentroid/5+yint4

Next N

Return(xint1, yint1, xint2, yint2, xint3, yint3, xint4, yint4)

Mathematics

The mathematics subroutine uses the displacements of the dots to calculate the forces F and the torques T.

### Mathematics(Alast, Blast, Clast, Dlast, Elast, Flast, Glast, Hlast, F1, F2, F3, T1, T2, T3)

The orthodontic bracket 412 is schematically depicted in FIGS. 8a to 8c as a block with the four corners cut off, leaving flat surfaces where the corners were. The dots 430-1 and 430-2 are on the corner faces 440 of the bracket 412. Looking at FIG. 8b, bracket 412 is shown from the side, the dots are shown on the corner faces 440 and the elastic layer 412-3 is positioned between them. The equations used to determine the forces and torques applied to orthodontic brackets are set forth below. The directions of the forces Fx, Fy and Fz are shown in FIG. 8a. The force Fx is along the long the length of bracket 412. Therefore, Fy is along the width bracket 412, and the force Fz is pointing up from the face of the bracket 412 (along the height). This forms a right handed coordinate system for Fx, Fy and Fz. The torques, T, are along their respective axes, that is Tx causes a rotation about the x axis as given by the right hand rule. A positive Tx will cause the top of bracket 412 in FIG. 8a to come towards an observer, and the bottom of the bracket 412 to go away from the observer. The torques are calculated about the geometric center of the elastic layer 412-3.

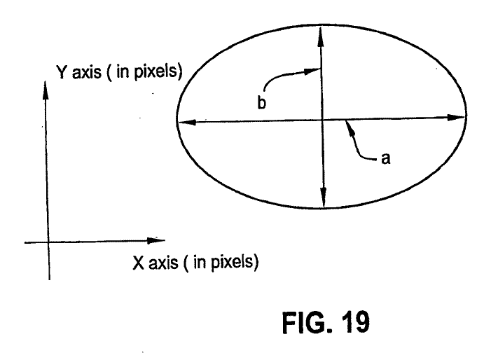

The faces of corners 440 of bracket 412 are numbered, 440-1 to 440-4, as shown in FIG. 19. The image of face 1 obtained by optical detector 16, is stored in Image 1.bmp; and so forth. The resultant displacements of the dots along A, B, C, etc. can be written in terms of the forces and torques. The equations for an arbitrary bracket, with arbitrarily chosen numbers 1, 0.9, 0.7 and 0.6, are set forth below:

A=0*Fx+0*Fy+1*Fz+−0.6*Tx+−1*Ty+0*Tz Eq 1

B=0.7*Fx+0.7*Fy+0*Fz+0*Tx+0*Ty+0.9*Tz Eq 2

C=0*Fx+0*Fy+1*Fz+0.6*Tx+−1*Ty+0*Tz Eq 3

D=−0.7*Fx+0.7*Fy+0*Fz+0*Tx+0*Ty+0.9*Tz Eq 4

E=0*Fx+0*Fy+1*Fz+0.6*Tx+1*Ty+0*Tz Eq 5

F=−0.7*Fx+−0.7*Fy+0*Fz+0*Tx+0*Ty+0.9*Tz Eq 6

G=0*Fx+0*Fy+1*Fz+−0.6*Tx+1*Ty+0*Tz Eq 7

H=0.7*Fx+−0.7*Fy+0*Fz+0*Tx+0*Ty+0.9*Tz Eq 8

These equations are first order approximations. More complicated equations can be written, but they are not needed.

Set the variables

### AFz=1

### ATx=0.6

### BFx=0.7

### BTz=0.9

A=++AFz*Fz+−ATx*Tx+AFz*Ty+ Eq 1

B=BFx*Fx+BFx*Fy++++BTz*Tz Eq 2

C=++AFz*Fz+ATx*Tx+−AFz*Ty+ Eq 3

D=−BFx*Fx+BFx*Fy++++BTz*Tz Eq 4

E=++AFz*Fz+ATx*Tx+AFz*Ty+ Eq 5

F=−BFx*Fx+−BFx*Fy++++BTz*Tz Eq 6

G=++AFz*Fz+−ATx*Tx+AFz*Ty+Eq 7

H=BFx*Fx+−BFx*Fy++++BTz*Tz Eq 8

### Now Eq2−Eq4−Eq6+Eq8

B−D−F+H=4*BFx*Fx

Fx=(B−D−F+H)/(4*BFx)

### Now Eq2+Eq4−Eq6−Eq8

B+D−F−H=4*BFX*Fy

Fy=(B+D−F−H)/(4*BFx)

### Now Eq1+Eq3+Eq5+Eq7

A+C+E+G=4*AFz*Fz

Fz=(A+C+E+G)/(4*AFz)

### Now −Eq1+Eq3+Eq5−Eq7

−A+C+E−G=4*ATx*Tx

Tx=(−A+C+E−G)/(4*ATx)

### Now −Eq1−Eq3+Eq5+Eq7

−A−C+E+G=4*AFz*Ty

Ty=(−A−C+E+G)/(4*AFz)

### Now Eq2+Eq4+Eq6+Eq8

B+D+F+G=4*BTz*Tz

Tz=(B+D+F+G)/(4*BTz)

A solution for the forces and torques is then found. The forces and torques are given as:

Fx=(B−D−F+H)/(4*BFx)

Fy=(B+D−F−H)/(4*BFx)

Fz=(A+C+E+G)/(4*AFz)

Tx=(−A+C+E−G)/(4*ATx)

Ty=(−A−C+E+G)/(4*AFz)

Tz=(B+D+F+G)/(4*BTz)

Where the A, B, C, D, E, F and are measured in pixels. That is, these are Alast, Blast, Clast, Dlast, Blast, Flast and Glast. The Mathematics subroutine is:

Mathematics(Alast, Blast, Clast, Dlast, Elast, Flast, Glast, Hlast, F1, F2, F3, T1, T2, T3)

AFz=1

ATx=0.6

BFx=0.7

BTz=0.9

F1=(Blast−Dlast−Flast+Hlast)/(4*BFx)

F2=(Blast+Dlast−Flast−Hlast)/(4*BFx)

F3=(Alast+Clast+Elast+Glast)/(4*AFz)

T1=(−Alast+Clast+Elast−Glast)/(4*ATx)

T2=(−Alast−Clast+Elast+Glast)/(4*AFz)

T3=(Blast+Dlast+Flast+Glast)/(4*BTz)

### Return(F1, F2, F3, T1, T2, T3)

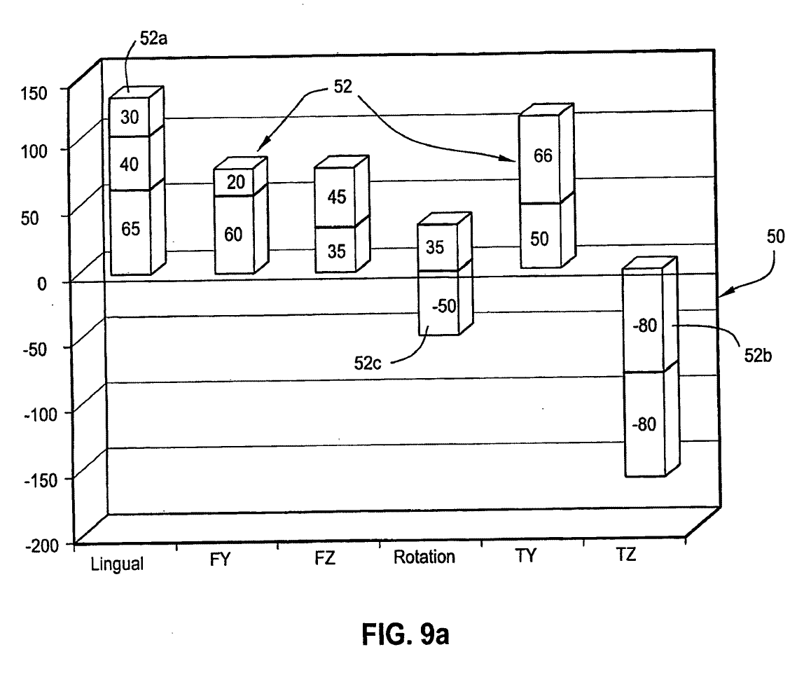

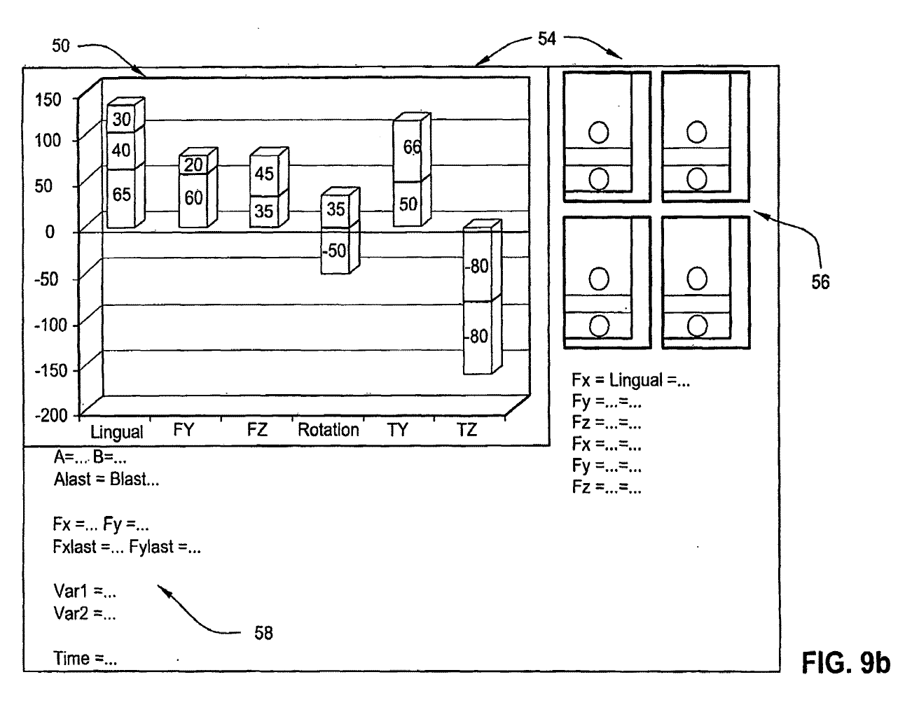

There are two output displays provided by processor 18 and displayed by monitor 20 and computer 22. Examples of these displays are depicted in FIGS. 9a and 9b. The first display, an example of which is shown in FIG. 9a, is a simple bar graph display 50. Each of the bars 52 shown in this display represents one of the forces or torques applied to a tooth by an orthodontic bracket 412. The second display, an example of which is shown in FIG. 9b, is a detailed display 54 that shows the bar graph 50, plus images 56 from the four flat surfaces 440-1 to 440-4 and numeric values 58 of the dot motions and the corresponding forces and torques.

There are two display subroutines, i.e., SimpleDisplay and GeneralDisplay. The simple display shown in FIG. 20 shows a graph 50 of the forces and torques. The general display shown in FIG. 9b also gives the values of a number of variables and gives the images from optical detector 16.

### The Simple Display

SimpleDisplay (F1last, F2last, F3last, T1last, T2last, T3last)

Return( )

In the simple display 50 shown in FIG. 9a, the bar 52a to the left shows 65 units of force required for the tooth motion. An additional 40 units would be biologically tolerable. Bar 52a currently shows a total of 135 units, which is 30 units above the recommended maximum force. The bar 52b to the right shows, −160 units of force need, and only −80 units of force being currently applied. The bar 52c to the right of center shows −50 units required and +35 units being applied. This simple display is essentially what an orthodontist sees when adjusting the arch wire for a patient.

### The General Display

GeneralDisplay (F1last, F2last, F3last, T1last, T2last, T3last, F1, F2, F3, T1, T2, T3, Alast, Blast, Clast, Dlast, Elast, Flast, Glast, Hlast, A, B, C, D, E, F, G, H, Var1, Var2, Var3, Var4, . . . , time)

The general display shown in FIG. 9b shows the details of how the system works. In addition to the graph 50 of the forces and torques, as shown, are the four images from the four corners 440-1 to 440-4 of block 412, the movement of dots 430-1 and 430-2 and the change in forces. The underlying mathematics can also be seen from the Alast, Blast, etc. and other variables of interest available at the bottom of the display 54.

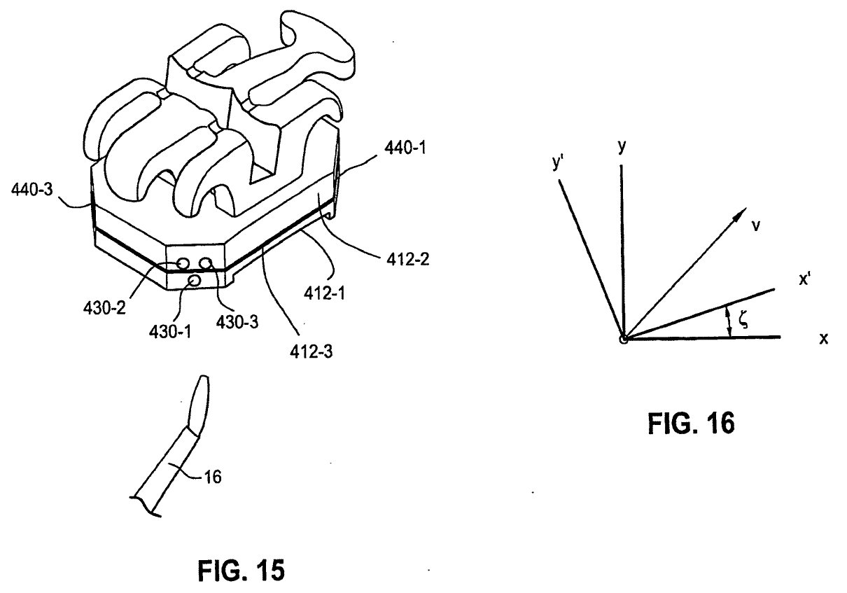

FIG. 15 shows the orthodontic bracket of FIGS. 8a-8c, but with two circular fiducials (green and blue) 430-2 and 430-3 on the upper portion of the bracket 412-2 and one circular fiducial (red) 430-1 below the elastic layer 412-3 on the bottom part 412-1 of the bracket. Although fiducials 430-1 to 430-3 are shown as circles, it should be understood that other shapes and designs can be substituted for such circles.

A picture of these fiducials taken by optical scanner 16 can be used to measure the distances between the bottom fiducial 430-1 and the top fiducials 430-2 and 430-3. Because scanner 16 is hand held, it will likely not be exactly perpendicular to the faces of bracket 412 including the fiducials. When a picture is taken of an object at an unknown distance and unknown camera angle, it is a very difficult problem to use the picture to determine the distances between the objects in the picture. The scale factors and distances for the picture of FIG. 15 can be calculated.

Below are described approximation methods and data manipulation techniques that greatly simplify the computer calculations that would be required to determine the distances between the fiducials shown in FIG. 15. Discussed above are first order calculations to measure the position (or center of mass) of objects in a picture, as measured in pixels.

In addition to the first order calculations described above for finding centroids, second order calculations are also used to determine the scale size of the picture. These second order moments of inertia multiply m times x² or x*y or y². The second moments Ixx, Ixy and Iyy are given below.

Ixx=Σᵢmᵢ*xᵢ²/Σᵢmᵢ

Ixy=Σᵢmᵢ*xᵢ*yᵢ/Σᵢmᵢ

Iyy=Σᵢmᵢ*yᵢ²/Σᵢmᵢ

These quantities can easily be described as a matrix M:

$$M = \vert \begin{matrix}Ixx & Ixy \\ - Ixy & Iyy\end{matrix} \vert$$

Below is discussed how to calculate the second moment of the image of a fiducial, diagonalize (a well known mathematical technique) the matrix M, and use the known size of the fiducial to calculate the scale size of a picture. In such calculations several coordinate transformations are performed. FIG. 16 shows a coordinate transformation from the coordinate system x and y to the coordinate system x′ and y′.

The vector V shown in FIG. 16 is given in the x and y coordinate system by the two numbers vx and vy; and the vector is given in the x′ and y′ coordinate system by the two numbers vx′ and vy′. The transformation between x′ and y′ and vx′ and vy′ is given in matrix form as:

$$\vert \begin{matrix}{vx}^{′} \\ {vy}^{′}\end{matrix} \vert = \vert \begin{matrix}cos ζ \\ - sin ζ\end{matrix} \vert * \vert \begin{matrix}sin ζ \\ cos ζ\end{matrix} \vert \vert \begin{matrix}vx \\ vy\end{matrix} \vert$$

or in equation form as

vx′=vx*cos ζ+vy*sin ζ

vy′=−vx*sin ζ+vy*cos ζ

There are well known mathematical techniques to transform the matrix M into a diagonal matrix M′,

$${M}^{′} = \vert \begin{matrix}sin ζ & sin ζ \\ - sin ζ & cos ζ\end{matrix} \vert * M$$

$$where$$

$${M}^{′} = \vert \begin{matrix}{I}^{′} xx & 0 \\ 0 & {I}^{′} yy\end{matrix} \vert$$

The diagonalized second order moment about the center of mass of an ellipse with principal axes a and b is given by

$${M}^{′} = \vert \begin{matrix}( 1 / 8 ) * {a}^{z} * {Σ}_{i} {m}_{i} & 0 \\ 0 & ( 1 / 8 ) * {b}^{2} * {Σ}_{i} {m}_{i}\end{matrix} \vert$$

and the values of the principal axes a and b are:

a=[8*I′xx/Σᵢmᵢ]^{1/2} and b=[8*I′yy/Σᵢmᵢ]^{1/2}

The coordinate transformations, matrix algebra, diagonalized matrixes discussed above are described in the book “Mathematical Methods in the Physical Sciences” by Mary L. Boas, John Wiley & Sons, Library of Congress Catalog Card Number: 66:17646, 1966, in chapter 10.

The second order moment about the center of mass of the object can be calculated from the second order moment about any arbitrary axes (for example, the second order moment about the center of mass can be calculated from the second order moment about the origin of the coordinate system) by the use of Steiner's parallel-axis theorem. (See for example, “Classical Dynamics of Particles and Systems” by Jerry B. Marion, Academic Press, 1971, Library of Congress Catalog Card Number 87-107545, page 373.)

The scale size is the ratio between physical distances and pixels. Consider a circle of diameter 1 millimeter (d=1 mm) that has been imaged. In a picture the circle might be 100 pixels in diameter. Then the scale size is 1 mm=100 pixels, and the distance in pixels (say 200 pixels) can be converted into a physical distance by multiplying the distance in pixels times (Scale_factor=1 mm/100 pixels), and the 200 pixels represent a physical distance of 2 mm. This is represented by the equation:

distance in mm=scale_factor*distance in pixels

This scale size in a picture can change depending upon the location and orientation of an object in the image. For example, the x direction might have a different scale size than the y direction. Or the x direction might have a different scale sizes at the top and bottom of the picture.

It is convenient to use a Taylor power series to represent the scale size. For example, the scale size in the x direction might be given by a Taylor series:

Scale_{—}x=A₀+A₁*(x−a)+A₂*(x−a)²+A₃*(x−a)³+ . . .

and the scale size in the y direction:

Scale_{—}y=B₀+B₁*(y−a)+B₂*(y−ahu 2+B₃*(y−a)³+ . . .

where the A's and B's are constants that need to be determined. Given the scale size in the picture, the distance between different points in the picture can then be calculated.

Initially, the first term of the Taylor series is considered. In an initial approximation, the scale size is constant across the image:

Scale_x=A₀

and

Scale_y=B₀

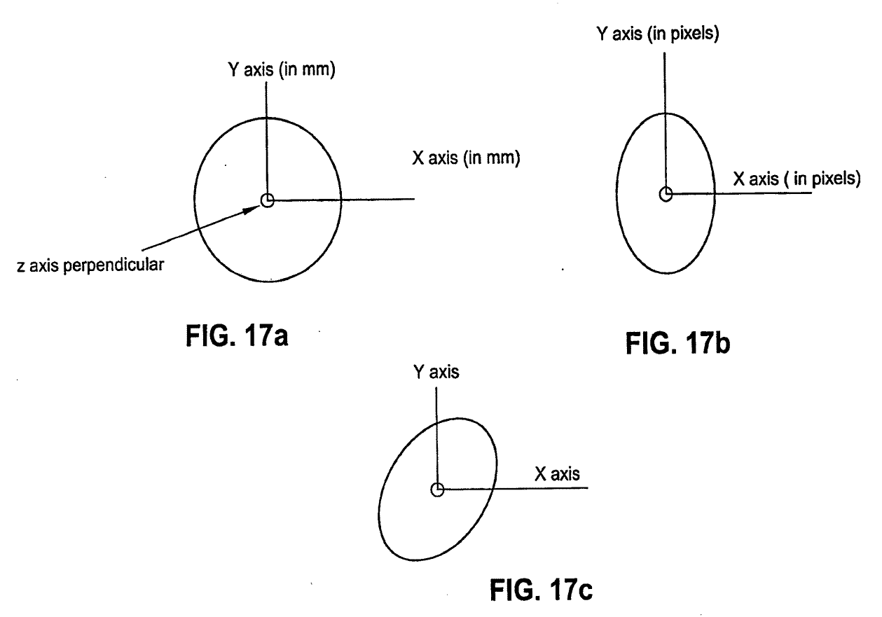

Considering a circle, as shown in FIG. 17a, on a flat plane or a piece of paper and a camera, like scanner 16, taking a picture at some odd angle (that is, the camera does not lie on the perpendicular coming out of the center of the circle), the coordinate system can be transformed so the camera is above the x axis. That is, if the x and y coordinates lie in the plane of the circle and the z axis is coincident with the circle perpendicular, the camera lies in the plane defined by the x and z axes. The image as seen in FIG. 17a is often foreshortened, as shown in FIG. 17b.

### Now,

distance in mm=scale_factor*distance in pixels using the scale factors above, the point given by x and y (in mm) are given in pixels as

x=pixel_{—}x*(A₀)

y=pixel_{—}y*(B₀)

The equation of the circle (in mm) is

x²+y²=r²

And this equation of a circle can be rewritten in terms of the pixels as:

pixel_{—}x²*(A₀)²+pixel_{—}y²*(B₀)²=r²

But this is just the equation of an ellipse in the pixel coordinate system. Hence, a circle on a piece of paper appears as an ellipse in the picture of FIG. 17b.

The coordinate system is oriented so that the camera is over the x axis and the principal axes of the ellipse lay along the x and y axes. Without this orientation, the principal axes would have been at some arbitrary angle as shown in FIG. 17c.

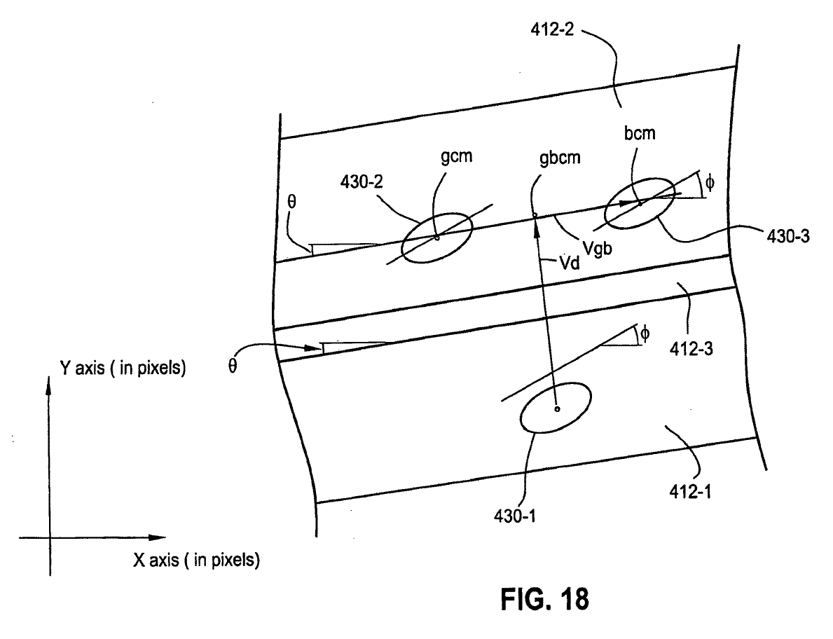

Turning again to the bracket of FIG. 15 with the fiducials 430-1, 430-2 and 430-3, FIG. 18 shows what scanner 16 sees when it looks at the three circular fiducials (green, blue and red). Here in the pixel coordinate system of the picture, the circles have been changed into ellipses, where theta, θ, is the angle the bracket is rotated in the picture and phi, φ, is the angle of the major axes of the ellipses. These angles are relative to the X axis of the camera's pixel coordinate system. The gcm, bcm and rcm are the center of mass of the green, blue and red ellipses, respectively; and the gbcm is the center of mass of the combined green and blue ellipse. The vector Vd is between gbcm, the center of mass of the green and blue ellipses and rcm, the center of mass of the red ellipse. The vector Vgb is the vector between the center of mass of the green and blue ellipse. Ultimately, the vector Vd is measured in physical dimensions (mm).

The pictures considered are all digital, that is they are composed of pixels. In a typical camera there are a million pixels (or more). Typically one looks at a pixel and its surrounding pixels, and attempts to find objects. If only nearest neighbor pixels are used in the analysis, each pixel must not only be examined, but also compared with its 8 nearest neighbors. Results must be extracted for both the x and y directions in the picture coordinate system. Each of the examinations and comparisons typically requires many calculations. Plus these calculations must be done for each of the three primary colors. If a picture has 1 million pixels, there are at least 1 million times 8 nearest neighbor pixels times the two coordinate axes and three colors: giving on the order of 48 million calculations that are required to analyze the picture. (Also, colors not represented by the primary colors should be analyzed, and calculations between the colors must also be performed.) One of the reasons analyzing a picture is a very difficult problem is because of the large mass of calculations that must be performed.

A simpler method, i.e., one that only extracts the wanted information, deals only with individual pixels without concern for the nearest neighbors, and ignores the fine details that cause the large number of calculations discussed above, is preferred. The second order calculations used by the present invention only calculate the wanted information. The picture taken by the scanner 16 may produce a poor image with irregular edges and pixels showing the incorrect color. The second order technique of the present invention produces the major and minor axes and orientation of the ellipse that best fits this poor image. Only three sums, Ixx and Ixy and Iyy, need be calculated, such that nearest neighbors and finding objects are not of concern. Also, once the picture has been digitized into pixels, all of the calculations are exact and no information is lost in the calculations.

For a second order calculation on the ellipse shown in FIG. 19, the second order calculation returns the principal axes, a and b, and the angle between the principal axis (in this case a) and the X axis. In FIG. 19, the angle between the principal axis and the X axis is zero.

This makes an extreme simplification of the results. Each pixel is examined once. Ragged edges do not throw off the edge finding algorithm that is required in many vision analysis; No decisions need be made about which is what, since nearest neighbor calculations are not required. The simple mathematics generates three sums that give the size and orientation of the object.

The steps in the preferred implementation are:

Find the first moment (center of mass) of each of the colored ellipses. Find the center of mass of the combined green and blue ellipse.

Find the vector Vd (in pixels) between the center of mass of the red ellipse, rcm, and the center of mass of the combined green and blue ellipse, gbcm.

Find the vector, Vgb, between the center of mass of the green ellipse and the center of mass of the blue ellipse. Find the angle theta, θ, between the Vgb and the X axis.

Examine one of the ellipse, say the green ellipse. Find the second order moments of this green ellipse. Diagonolize these moments and find the principal axes, a and b, and the angle of rotation phi, φ.

Transform the vector Vd, into a new primed coordinate system that is rotated an angle phi, θ with respect the original coordinate system X and Y. In this new coordinate system the X′ and Y′ axes are aligned with the principal axes of the green ellipse.

Using the known size of the green circle on the bracket, Rg (in mm), and the measured size of the green ellipse principal axes (in pixels), calculate the scale factors along the X′ and Y′ axes.

Transform the X′ and Y′ components of the vector Vd from pixels to millimeters using the scale factors. (A transformation into the X′ and Y′ coordinates is done so that the principal axes can be used to calculate the scale factors along the X′ and Y′ axes—the X′ and Y′ axes being parallel to the principal axes.)

Transform the vector Vd into a coordinate system parallel to the vector Vgb. This is done by doing a coordinate transformation on the above vector Vd (in mm) through an angle of (theta θ-phi φ). This new coordinate system has axes of X″ and Y″.

This final vector Vd in the double prime coordinate system gives the actual physical separation in millimeters between the center of mass of the red fiducial on the bottom of the bracket and the center of mass of the green and blue fiducials on the top of the bracket. Motions of the top of the bracket relative to the bottom of the bracket can detected by noting how Vd changes in successive pictures.

Any point in the picture can be identified and a vector drawn from the origin of the X and Y coordinate system to that point. Transforming this vector as above then gives the actual physical distance from the origin to this point. By continuing this process, all the distances in the picture can be measured.

As mentioned above, higher order terms of x and y can be used to more accurately represent the scale factors. For example, consider the scale factors below that allow for linear gradients in the x and y directions.

Scale_{—}x(x,y)=A₀+A₁*x+AB₁*y

and

Scale_{—}y(x,y)=B₀+B₁*y+BA₁*x

Using the green, blue and red ellipses to determine the constants in the gradient scale factors above, first the second moments of each of the three ellipses are calculated and then their principal axes and angle of rotation are calculated. This information is used to calculate the scale factors at each of the center of mass of the three ellipses.

The scale factor is known at three points in the picture, at gcm, bcm and rcm. This allows a determination of the over all scale factor and the gradient in the x and y direction.

Let the scale factor at gcm be Scale_xg and Scale_yg and the coordinates of the center of mass be xg and yg. And similarly for the blue and red ellipse: Scale_xb, Scale_yb, xb, yb Scale_xr, Scale_yr xr and yr. Then

Scale_{—}xg=A₀+A₁*xg+AB₁*yg

Scale_{—}yg=B₀+B₁*yg+BA₁*xg

Scale_{—}xb=A₀+A₁*xb+AB₁*yb

Scale_{—}yb=B₀+B₁*yb+BA₁*xb

Scale_{—}xr=A₀+A₁*xr+AB₁*yr

Scale_{—}yr=B₀+B₁*yr+BA₁*xr

Given the six unknowns, A₀, A₁, AB₁, B₀, B₁ and BA₁, and six equations, the scale factors can be solved.

Additional colored circles can be placed on the object being imaged, and their respective ellipses in the pictures can be used to extract additional information for higher order approximations to the scale factors. Also, if the camera is imaging several different planes on the object, appropriate fiducials can be placed on each plane.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of determining a force and/or torque applied to an orthodontic bracket comprising the steps of:
applying to the orthodontic bracket at least one pair of fiducials so that the fiducials are visibly movable with respect to one another in response to movement of a first part of the bracket relative to a second part of the bracket,
imaging the fiducials,
analyzing at least one of the fiducials in the image to determine relative movement between the fiducials, the analysis comprising the steps of:
forming a first sum of each of a plurality of pixels comprising the fiducial times the square of the distance of the pixel from the origin of the image's coordinate system along the image's x axis,
forming a second sum of each of the pixels comprising the fiducial times the distance of the pixel from the origin of the image's coordinate system along the image's x axis times the distance of the pixel from the image's coordinate system along the image's y axis,
forming a third sum of each of the pixels comprising the fiducial times the square of the distance of the pixel from the origin of the image's coordinate system along the image's y axis,
forming a first square matrix with four elements, wherein the first matrix' upper left element is the first sum divided by the number of pixels comprising the fiducial, the first matrix' upper right element is the second sum divided by the number of pixels comprising the fiducial, the first matrix' lower left element is the negative of the second sum divided by the number of pixels comprising the fiducial, and the first matrix' lower right element is the third sum divided by the number of pixels comprising the fiducial,
diagonalizing the first matrix into a second matrix,
setting the fiducial's first principal axis equal to the square root of the second matrix' upper left element times 8,
setting the fiducial's second principal axis equal to the square root of the second matrix' lower right element times 8, and
using the first and second principal axes to measure the size of the fiducial in the image, and
storing the size of the fiducial in a computer memory.

2. The method of claim 1, wherein the first and second principal axes are used to determine the scale size of the image.

3. The method of claim 1, wherein the first and second principal axes are related to the physical size of the fiducial, and wherein the physical size of the first principal axis of the fiducial is divided by the first principal axis calculated from the image to determine the scale factor of the image along the direction of the first principal axis.

4. The method of claim 1, wherein the first and second principal axes are related to the physical size of the fiducial, and wherein the physical size of the second principal axis of the fiducial is divided by the second principal axis calculated from the image to determine the scale factor of the image along the direction of the second principal axis.

5. The method of claim 1, wherein the step of diagonalizing the first matrix into a second matrix uses an angle that is also used to determine the orientation of the fiducial in the image.

6. The method of claim 1, wherein the coordinate system of the image is rotated through an angle that is used to diagonalize the first matrix into the second matrix to form a second coordinate system, and wherein a scale size along the second coordinate system is calculated.

7. The method of claim 2, wherein the scale size of the image is used to calculate motions between the pair of fiducials.

8. The method of claim 2, wherein a plurality of fiducial pairs are applied to the orthodontic bracket, and wherein a plurality of images of the plurality of fiducial pairs applied to the bracket are analyzed to measure the force applied to the bracket.

9. The method of claim 1, wherein the fiducials are circles.

10. The method of claim 1, wherein the fiducials are squares.

11. The method of claim 1, wherein the fiducials are triangles.

12. The method of claim 1, wherein the fiducials are rectangles.

13. The method of claim 1, wherein the fiducials are irregular shapes.

14. The method of claim 1, wherein the size of the fiducial is converted to a known physical measuring system.

15. The method of claim 1, wherein the first and second principal axes are used to measure the sizes of other objects in the image.

16. The method of claim 1, wherein the image is originally an analog image that is digitized into pixels.

17. The method of claim 1, wherein the orthodontic bracket further comprises an elastic member for allowing the first and second parts of the bracket to move resiliently with respect to one another.

18. The method of claim 1, wherein at least three fiducials are applied to the orthodontic bracket, two of the fiducials being applied to one part of the bracket, and one of the fiducials being applied to the other part of the bracket, the two fiducials on one part of the bracket being paired with the one fiducial on the other part of the bracket.

19. A method of determining a force and/or torque applied to an orthodontic bracket comprising a first part attached to a tooth, a second part for receiving an applied force, and an elastic member for allowing resilient movement between the first and second parts of the bracket, the method comprising the steps of:
applying to the orthodontic bracket a plurality of pairs of fiducials so that each of the pairs of fiducials are visibly movable with respect to one another in response to movement of the first part relative to the second part, the bracket relative to a second part of the bracket,
optically detecting each of the pairs of fiducials to produce a plurality of analog images of the fiducial pairs that are then digitized, and
analyzing at least one of the fiducials in each of the images to determine relative movement between the pair of fiducials in the image, the analysis comprising the steps of:
forming a first sum of each of a plurality of pixels comprising the fiducial times the square of the distance of the pixel from the origin of the image's coordinate system along the image's x axis,
forming a second sum of each of the pixels comprising the fiducial times the distance of the pixel from the origin of the image's coordinate system along the image's x axis times the distance of the pixel from the image's coordinate system along the image's y axis,
forming a third sum of each of the pixels comprising the fiducial times the square of the distance of the pixel from the origin of the image's coordinate system along the image's y axis,
forming a first square matrix with four elements, wherein the first matrix' upper left element is the first sum divided by the number of pixels comprising the fiducial, the first matrix' upper right element is the second sum divided by the number of pixels comprising the fiducial, the first matrix' lower left element is the negative of the second sum divided by the number of pixels comprising the fiducial, and the first matrix' lower right element is the third sum divided by the number of pixels comprising the fiducial,
diagonalizing the first matrix into a second matrix,
setting the fiducial's first principal axis equal to the square root of the second matrix' upper left element times 8,
setting the fiducial's second principal axis equal to the square root of the second matrix' lower right element times 8,
using the first and second principal axes to measure the size of the fiducial in the image, and thus the scale size of the image, and
using the scale size of the image to calculate motions between the pair of fiducials, and
displaying on a monitor the calculated motions between the pair of fiducials.

20. A system for determining a force and/or torque applied to an orthodontic bracket comprising:
an orthodontic bracket including at least one pair of fiducials so that the fiducials are visibly movable with respect to one another in response to movement of a first part of the bracket relative to a second part of the bracket,
an optical detector for imaging the fiducials,
a processor for analyzing at least one of the fiducials in the image to determine relative movement between the fiducials, the fiducial being comprised of a plurality of pixels, the processor performing the functions of:
forming a first sum of each of the pixels comprising the fiducial times the square of the distance of the pixel from the origin of the image's coordinate system along the image's x axis,
forming a second sum of each of the pixels comprising the fiducial times the distance of the pixel from the origin of the image's coordinate system along the image's x axis times the distance of the pixel from the image's coordinate system along the image's y axis,
forming a third sum of each of the pixels comprising the fiducial times the square of the distance of the pixel from the origin of the image's coordinate system along the image's y axis,
forming a first square matrix with four elements, wherein the first matrix' upper left element is the first sum divided by the number of pixels comprising the fiducial, the first matrix' upper right element is the second sum divided by the number of pixels comprising the fiducial, the first matrix' lower left element is the negative of the second sum divided by the number of pixels comprising the fiducial, and the first matrix' lower right element is the third sum divided by the number of pixels comprising the fiducial,
diagonalizing the first matrix into a second matrix,
setting the fiducial's first principal axis equal to the square root of the second matrix' upper left element times 8,
setting the fiducial's second principal axis equal to the square root of the second matrix' lower right element times 8, and
using the first and second principal axes to measure the size of the fiducial in the image, and
a computer memory for storing the size of the fiducial.

21. A method of determining a force and/or torque applied to an orthodontic bracket comprising the steps of:
applying to the orthodontic bracket at least one pair of fiducials that are visibly movable with respect to one another in response to movement of a first part of the bracket relative to a second part of the bracket,
imaging the fiducials,
analyzing at least one of the fiducials in the image to determine relative movement between the fiducials, the analysis comprising the steps of:
for each of a plurality of pixels comprising the fiducial, multiplying the mass of the pixel first, by the square of the distance of the pixel along the x axis of the image's coordinate system, second, by the product of the distances of the pixel along the x and y axes of the image's coordinate system, and third, by the square of the distance of the pixel along the y axis of the image's coordinate system,
determining the second order xx, xy and yy moments of inertia about the centroid of the fiducial by calculating separate sums of each of the first, second and third multiplications, and dividing the sums by the number of pixels comprising the fiducial,
forming a first matrix with an upper left element that is the second order xx moment of inertia, an upper right element that is the second order xy moment of inertia, a lower left element that is the negative of the second order xy moment of inertia, and a lower right element that is the second order yy moment of inertia,
diagonalizing the first matrix into a second matrix,
setting the fiducial's first principal axis equal to the square root of the second matrix' upper left element times 8,
setting the fiducial's second principal axis equal to the square root of the second matrix' lower right element times 8, and
using the first and second principal axes to measure the size of the fiducial in the image, and
storing the size of the fiducial in a computer memory.

22. A method of determining the size of an object in an image comprising the steps of:
forming a first sum of each of a plurality of pixels comprising the object times the square of the distance of the pixel from the origin of the image's coordinate system along the image's x axis,
forming a second sum of each of the pixels comprising the object times the distance of the pixel from the origin of the image's coordinate system along the image's x axis times the distance of the pixel from the image's coordinate system along the image's y axis,
forming a third sum of each of the pixels comprising the object times the square of the distance of the pixel from the origin of the image's coordinate system along the image's y axis,
forming a first square matrix with four elements, wherein the first matrix' upper left element is the first sum divided by the number of pixels comprising the object, the first matrix' upper right element is the second sum divided by the number of pixels comprising the object, the first matrix' lower left element is the negative of the second sum divided by the number of pixels comprising the object, and the first matrix' lower right element is the third sum divided by the number of pixels comprising the object,
diagonalizing the first matrix into a second matrix,
setting the object's first principal axis equal to the square root of the second matrix' upper left element times 8,
setting the object's second principal axis equal to the square root of the second matrix' lower right element times 8, and
using the first and second principal axes to measure the size of the object in the image, and
storing the size of the object in a computer memory.

23. The method of claim 22, wherein the first and second principal axes are used to determine the scale size of the image.

24. The method of claim 22, wherein the first and second principal axes are related to the physical size of the object, and wherein the physical size of the first principal axis of the object is divided by the first principal axis calculated from the image to determine the scale factor of the image along the direction of the first principal axis.

25. The method of claim 22, wherein the first and second principal axes are related to the physical size of the object, and wherein the physical size of the second principal axis of the object is divided by the second principal axis calculated from the image to determine the scale factor of the image along the direction of the second principal axis.

26. The method of claim 22, wherein the step of diagonalizing the first matrix into a second matrix uses an angle that is also used to determine the orientation of the object in the image.

27. The method of claim 22, wherein the coordinate system of the image is rotated through an angle that is used to diagonalize the first matrix into the second matrix to form a second coordinate system, and wherein a scale size along the second coordinate system is calculated.

28. The method of claim 23, wherein the image includes a pair of objects movable relative to one another, and wherein the scale size of the image is used to calculate motions between the pair of objects.

29. The method of claim 28, wherein the pair of objects is a pair of fiducial applied to an orthodontic bracket comprised of first and second parts movable relative to one another, and wherein an image of the fiducial pair applied to the bracket is analyzed to measure relative movement between the pair of fiducials and thereby a force applied to the bracket.

30. The method of claim 22, wherein the object is a circle.

31. The method of claim 22, wherein the object is a square.

32. The method of claim 22, wherein the object is a triangle.

33. The method of claim 22, wherein the object is a rectangle.

34. The method of claim 22, wherein the object is an irregular shape.

35. The method of claim 22, wherein the size of the object is converted to a known physical measuring system.

36. The method of claim 22, wherein the first and second principal axes are used to measure the sizes of other objects in the image.

37. The method of claim 22, wherein the image is originally an analog image that is digitized into pixels.

38. A system for determining a force and/or torque applied to an orthodontic bracket comprising:
an orthodontic bracket including at least one pair of fiducials that are visibly movable with respect to one another in response to movement of a first part of the bracket relative to a second part of the bracket,
an optical scanner for imaging the fiducials,
a processor for analyzing at least one of the fiducials in the image to determine relative movement between the fiducials, the processor performing the functions of:
for each of a plurality of pixels comprising the fiducial, multiplying the mass of the pixel first, by the square of the distance of the pixel along the x axis of the image's coordinate system, second, by the product of the distances of the pixel along the x and y axes of the image's coordinate system, and third, by the square of the distance of the pixel along the x axis of the image's coordinate system,
determining the second order xx, xy and yy moments of inertia about the centroid of the fiducial by calculating separate sums of each of the first, second and third multiplications, and dividing the sums by the number of pixels comprising the fiducial,
forming a first matrix with an upper left element that is the second order xx moment of inertia, an upper right element that is the second order xy moment of inertia, a lower left element that is the negative of the second order xy moment of inertia, and a lower right element that is the second order yy moment of inertia,
diagonalizing the first matrix into a second matrix,
setting the fiducial's first principal axis equal to the square root of the second matrix' upper left element times 8,
setting the fiducial's second principal axis equal to the square root of the second matrix' lower right element times 8, and
using the first and second principal axes to measure the size of the fiducial in the image, and
storing the size of the fiducial in a computer memory.
